(19) United States
(12) Patent Application Publication
(10) Pub. No.: US 2022/0067107 A1
(43) Pub. Date: Mar. 3, 2022

(54) MULTI-SECTION SEQUENTIAL DOCUMENT MODELING FOR MULTI-PAGE DOCUMENT PROCESSING

(71) Applicant: CONCORD III, LLC, Seattle, WA (US)

(72) Inventors: Matthew A. Overlund, Brentwood, TN (US); Ashwin Suresh Kumar, Singapore (SG)

(21) Appl. No.: 17/009,112

(22) Filed: Sep. 1, 2020

(51) Int. Cl. G06F 16/93; G06F 40/117; G06F 40/134

(52) U.S. Cl. CPC G06F 16/94; G06F 40/134; G06F 40/117

(57) ABSTRACT

A document classification method includes processing pages of a document, page by page. For each page, it is determined whether the page contains a transition from one section to another, or if the page contains no transitions. The method additionally includes constructing for the document, a sequence of tags in the memory beginning with an initial tag for an initial page and then a next tag for a next page and continuing with a different tag for each other page in sequential order of the pages leading to a final tag corresponding to a final page. Each tag in the sequence indicates whether a corresponding one of the pages includes or lacks a transition. Finally, the method includes comparing the constructed sequence to a set of previously stored sequences in order to identify a match and classifying the document according to a classification previously associated with the matching sequence.

### BACKGROUND OF THE INVENTION

### Field of the Invention

The present invention relates to the field of document processing and more particularly to document classification during document processing.

### Description of the Related Art

Text analysis refers to the digital processing of an electronic document in order to understand the context and meaning of the sentences terms and phrases included therein. Traditional text analysis begins with a parsing of the document to produce a discrete set of words. Thereafter, different techniques can be applied to the set of words in order to identify terms, phrases and their associations and to ascertain a meaning of each of the sentences. Traditionally, parts-of-speech analysis and natural language processing (NLP) may be applied in the latter instance in order to determine potential meaning for each of the sentences. Finally, the determined for each of the sentences meaning may be composited into an overall document classification or characterization, such as indicating a nature or topic of the document and a specific notion in respect to the topic.

To facilitate text analysis of a document, it is helpful to understand a context of the document. By understanding the context of the document, limitations may be placed upon the interpretation of text based upon the expectations resulting from the known context of the document. For instance, a document that has been classified as an insurance form relating to an insurance claim is expected to conform to a particular format and include particular information, oftentimes in a proscribed order and even at a pre-determined position within the document. As such, a limited dictionary of expected terms or types of terms may be applied to a specific document of specific classification and even for a specific position within the document of the specific classification.

Presently, to understand the context or classification of a document generally requires reading enough content of the document to correlated present terms with a known document type. For instance, a document that includes terms such as “insurance” or “claim” may be presumed to indicate an insurance claim form. Alternatively, a visual recognition of different sections of a document may be visually determinative of a corresponding classification. For example, recognizing a large font heading with a proper name and a photographic image of a person at a corner portion of the same document may result in the conclusion that the document is a resume. More recently, convolutional neural networks have been trained to conclude that the visual structure of a document may be associated with a specific document class.

Notwithstanding, it is not always the case that a document subject to processing consists of a single page. Moreover, it is commonly understood that a document of multiple pages may include different sections thus complicating the simple application of a neural network to the multi-page document for the purpose of classifying the document. Even further, it is often the case that a multi-page document consists of multiple different documents bundled together in a single file to produce, in essence, a multi-section document of unrelated or semi-related sections. The latter occurs when multiple, independent documents are scanned into a single document packet (file), or when multiple, independent documents are faxed as a single image file to a destination fax machine. In this instance, it is possible if not likely that the simple application of a neural network will result in the mis-classification of the multi-page document of multiple sections.

### BRIEF SUMMARY OF THE INVENTION

Embodiments of the present invention address deficiencies of the art in respect to document classification and provide a novel and non-obvious method, system and computer program product for document classification according to a sequential model of intra-document transitions. In an embodiment of the invention, a multi-page document may be loaded into memory of a computer so that a multiplicity of its pages are processed, page by page. For each page, it is determined whether the page contains a transition from one section to another, or if the page contains no transitions from one section to another. Then, a sequence of tags is constructed in memory for the multi-page document, beginning with an initial tag for an initial one of the pages and then a next tag for a next one of the pages and continuing with a different tag for each of the pages in sequential order of the pages leading to a final tag corresponding to a final one of the pages. In this regard, each tag in the sequence indicates whether a corresponding one of the pages includes or lacks a transition. Optionally, each tag in the sequence specifically indicates whether a corresponding one of the pages includes a beginning of a new section of the document, an ending of a current section of the document, or includes only content pertaining to the current section of the document.

Thereafter, the constructed sequence is compared to a set of previously stored sequences in order to identify a matching sequence. Finally, the multi-page document may be classified according to a class of the matched stored sequence. For instance, the classification may indicate a type of the document with known document sections. Of note, in one aspect of the embodiment, the previously stored sequences are generated from a training set of corresponding documents of known classes, each known classification being correlated with a specific sequence of tags.

In another embodiment of the invention, a document processing system is configured for document classification. The system includes a host computing platform of one or more computers, each with memory and at least one processor, and a table disposed in the memory and correlating different sequences of tags with different document classifications. The system also includes a document classification module. The module includes computer program instructions executing in the memory of the platform so as to load a multi-page document into memory, process a multiplicity of pages of the multi-page document in memory, page by page, and for each of the pages, determining whether the page contains a transition from one section to another, or if the page contains no transitions from one section to another. The program instructions further construct for the multi-page document, a sequence of tags in memory beginning with an initial tag for an initial one of the pages and then a next tag for a next one of the pages and continuing with a different tag for each of the pages in sequential order of the pages leading to a final tag corresponding to a final one of the pages, each tag in the sequence indicating whether a corresponding one of the pages includes or lacks a transition. Finally, the program instructions compare the constructed sequence to the different sequences in the table in order to identify a matching one of the sequences and classify the multi-page document according to a classification correlated to the matching one of the stored sequences.

Additional aspects of the invention will be set forth, either directly or implied, in the description which follows, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is pictorial illustration of a process for document classification according to a sequential model of intra-document transitions;

FIG. 2 is a schematic illustration of a document data processing system adapted for document classification according to a sequential model of intra-document transitions; and,

FIG. 3 is a flow chart illustrating a process for document classification according to a sequential model of intra-document transitions.

### DETAILED DESCRIPTION OF THE INVENTION

Embodiments of the invention provide for document classification according to a sequential model of intra-document transitions. In accordance with an embodiment of the invention, a document classifier pre-processes a multi-page document subject to document content processing by generating, for each page of the multi-page document, an indication within meta-data such as a tag, of whether or not a transition from one section to another subsists within the page. A sequence of tags for the pages are then combined into a sequential pattern for the multi-page document and compared to a pre-existing set of sequential patterns, each of the patterns in the pre-existing set having an association with a corresponding document classification. Upon matching the sequential pattern for the multi-page document with a corresponding entry in the pre-existing set, the classifier assigns to the multi-page document, the document classification for the corresponding entry and submits the assigned classification and multi-page document to the content processor. In this way, the content processor may use the classification provided by the pre-processor in order to refine the processing of the content for greater speed and accuracy.

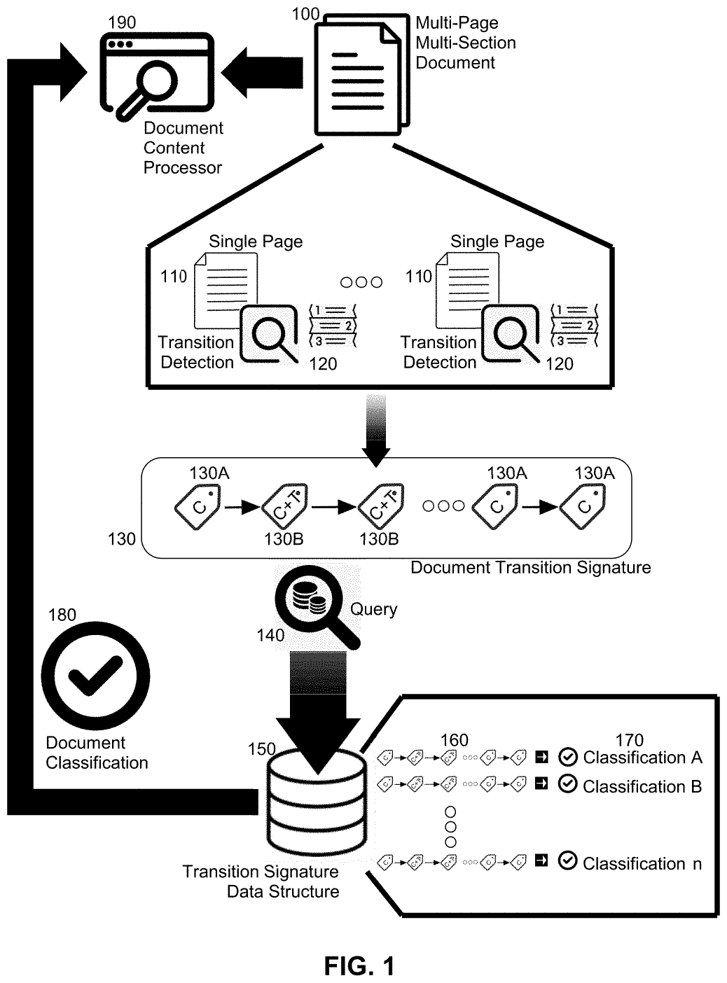

In further illustration, FIG. 1 pictorially shows a process for document classification according to a sequential model of intra-document transitions. As shown in FIG. 1, a document content processor 190 directs pre-processing of a multi-page, multi-section document 100 in order to classify the document 100. The document 100 includes multiple different pages 110 and transition detection logic 120 determines whether or not each of those pages 110 includes a section transition from one section to another. For instance, the transition detection logic 120 may identify a stand-alone heading indicative of a new section, the transition detection logic 120 may identify heading numbering indicative of a hierarchical change of topic or change of sub-topic. In the latter instance, by tracking heading numbering, the transition detection logic 120 may determine if a section transition reflects an end of a prior section and a beginning of a new section, or the continuation of a prior section and the beginning of a sub-section to the prior section, or the end of a prior sub-section and the beginning of a new sub-section, or the end of a prior sub-section and the beginning of a new section, to name just a few example.

For each of the pages 110 in the document 100, a tag 130A, 130B is generated indicating, at the minimum, whether or not a transition is present within a corresponding one of the pages 110, one tag 130A indicating the presence only of section content without transition in the corresponding one of the pages 110, and the other tag 130B indicating the presence of at least one transition. It will be recognized that other tags (not shown) are possible indicating a number of transitions within the corresponding one of the pages 110, or the specific nature of each detected transition such as end of section, beginning of sub-section, end of sub-section and beginning of section. In any event, a sequence of the tags 130A, 130B leading from an initial one of the pages 110 to a final one of the pages 110 may be linked together to form a sequential document transition signature 130.

The sequential document transition signature 130 may then be included within a query 140 against a data structure of transition signatures 150. The data structure of transition signatures 150 includes different entries between pre-existing signatures 160 and corresponding document classifications 170. Upon detecting a threshold match, for instance when a threshold number or percentage of the tags 130A, 130B in the sequential document transition signature 130 match those of one of the pre-existing signatures 160, the corresponding one of the classifications 170 is then determined to be the document classification 180 for the document 100. Thereafter, the determined document classification 180 is provided to the document content processor 190 for use in processing the content of the document 100.

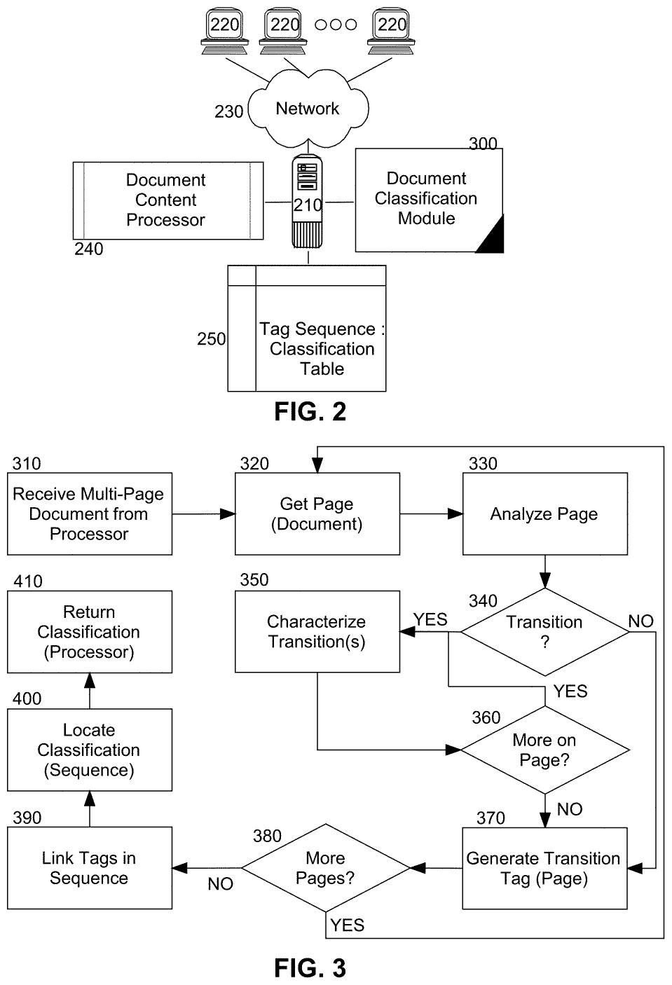

The process described in connection with FIG. 1 may be implemented within a document data processing system. In further illustration, FIG. 2 a schematically shows a document data processing system adapted for document classification according to a sequential model of intra-document transitions. The system includes a host computing platform 210 that includes one or more computers, each with memory and at least one processor. The host computing platform 210 is communicatively coupled to different computing clients 220 over computer communications network 230. A document content processor 240 executes within the host computing platform 210 and receives from the different computing clients 220 from over the computer communications network 230, different multi-page documents for content processing in the host computing platform 210. In one example, the multi-page documents can be fax images of one or more documents. In another example, the multi-page documents can be document scans of one or more documents.

Of note, the system includes a document classification module 300. The module 300 includes computer program instructions enabled during execution in the host computing platform 210 to pre-process a received multi-page document on behalf of the content processor 240. The pre-processing includes analyzing each page of the document in order to detect the presence of a transition within the page, and optionally, the nature transition or transitions present in the page. The pre-processing additionally includes generating a tag for each page indicating whether or not a transition is present in the page. The pre-processing yet further includes constructing a sequential signature of the document with a sequence of the tags and comparing the signature to entries in tag sequence classification table 250 correlating different pre-determined tag sequences with different pre-determined predetermined document classifications. The pre-processing even yet further includes selecting a threshold matching entry in the table 250 for the constructed sequential signature and applying a corresponding classification to the document for use in content processing the document in the content processor 240.

In even yet further illustration of the operation of the document classification module 300, FIG. 3 is a flow chart illustrating a process for document classification according to a sequential model of intra-document transitions. Beginning in block 310, a multi-page document is received from a document processor for pre-processing of a classification of the document. In block 320, a first page of the document is selected and in block 330, the page is analyzed to detect a first transition. For example, the text of the page can be parsed to detect a change in font from smaller to bigger indicating a heading, or to detect a roman numeral, letter or number of an outline, or to simply detect a stand-alone line with significant white space above and below the line. Alternatively, the image structure of the page may be image processed to identify imagery of discrete blocks of text with a break of whitespace therebetween so as to detect a break in content indicative of a section transition.

In decision block 340 it is determined if a transition has been encountered in the page. If not, in block 370 a tag is generated for the page indicating a page with only content and no transitions and stored in temporary memory. In decision block 380 it is then determined if further pages remain to processed in the document. If so, the process returns to block 320 with a retrieval of a next page of the document and an analysis of the page in block 330. In decision block 340, if a transition is detected within the page subject to analysis, in block 350 the transitions of the page are characterized in terms of any combination of a number of transitions present in the page, and for each transition in the page, whether or not the transition reflects the end of a previous section, the end of a previous sub-section, the beginning of a new sub-section or the beginning of a new section. In decision block 360 it is determined if more transitions are found in the page so as to require a refinement of the characterization. If so, in block 350 the characterization is refined to account for the additional transition and continues until it is determined in block 360 that no further transitions are found in the page.

In block 370 a tag is then generated indicative of the characterization of the transitions for the page. In decision block 380 if further pages in the document remain to be pre-processed, the process returns to block 320 with a retrieval of a next page of the document and an analysis of the page in block 330. In decision block 380, when no further pages in the document remain to be pre-processed, in block 390, the generated tags for the sequence of pages in the document are linked together as a sequence of tags. In block 400, the sequence of tags is then compared to a set of pre-existing tags, each correlated with a different document classification. Alternatively, the sequence of tags may be submitted to a convolutional neural network trained to produce a probability of a classification based upon a sequence of tags. Finally, in block 410, the classification determined for the sequence of tags is returned to the document content processor for use in content processing the multi-page document.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network. The computer readable program instructions may execute entirely on the user's computer, partly on the user's computer, as a stand-alone software package, partly on the user's computer and partly on a remote computer or entirely on the remote computer or server. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A document classification method comprising:
loading a multi-page document into memory of a computer;
processing a multiplicity of pages of the multi-page document in the memory, page by page, and for each of the pages, determining whether the page contains a transition from one section to another, or if the page contains no transitions from one section to another;
constructing for the multi-page document, a sequence of tags in the memory beginning with an initial tag for an initial one of the pages and then a next tag for a next one of the pages and continuing with a different tag for each of the pages in sequential order of the pages leading to a final tag corresponding to a final one of the pages, each tag in the sequence indicating whether a corresponding one of the pages includes or lacks a transition;
comparing the constructed sequence to a set of previously stored sequences in order to identify a matching one of the stored sequences; and,
classifying the multi-page document according to a classification previously associated with the matching one of the stored sequences.

2. The method of claim 1, wherein each tag in the sequence indicates whether a corresponding one of the pages includes a beginning of a new section of the document, an ending of a current section of the document, or includes only content pertaining to the current section of the document.

3. The method of claim 1, wherein the classification indicates a type of the document with known document sections.

4. The method of claim 1, further comprising, generating the previously stored sequences from a training set of corresponding documents of known classification, each known classification being correlated with a specific sequence of tags.

5. A document processing system configured for document classification, the system comprising:
a host computing platform comprising one or more computers, each with memory and at least one processor;
a table disposed in the memory and correlating different sequences of tags with different document classes; and,
a document classification module comprising computer program instructions executing in the memory of the platform, the instructions performing:
loading a multi-page document into the memory;
processing a multiplicity of pages of the multi-page document in the memory, page by page, and for each of the pages, determining whether the page contains a transition from one section to another, or if the page contains no transitions from one section to another;
constructing for the multi-page document, a sequence of tags in the memory beginning with an initial tag for an initial one of the pages and then a next tag for a next one of the pages and continuing with a different tag for each of the pages in sequential order of the pages leading to a final tag corresponding to a final one of the pages, each tag in the sequence indicating whether a corresponding one of the pages includes or lacks a transition;
comparing the constructed sequence to the different sequences in the table in order to identify a matching one of the sequences; and,
classifying the multi-page document according to a classification correlated to the matching one of the stored sequences.

6. The system of claim 5, wherein each tag in the sequence indicates whether a corresponding one of the pages includes a beginning of a new section of the document, an ending of a current section of the document, or includes only content pertaining to the current section of the document.

7. The system of claim 5, wherein the classification indicates a type of the document with known document sections.

8. The system of claim 5, wherein the program instructions during execution further perform generating the different sequences in the table from a training set of corresponding documents of known classification, each known classification being correlated with a specific sequence of tags.

9. A computer program product for document classification, the computer program product including a computer readable storage medium having program instructions embodied therewith, the program instructions executable by a device to cause the device to perform a method including:
loading a multi-page document into memory of a computer;
processing a multiplicity of pages of the multi-page document in the memory, page by page, and for each of the pages, determining whether the page contains a transition from one section to another, or if the page contains no transitions from one section to another;
constructing for the multi-page document, a sequence of tags in the memory beginning with an initial tag for an initial one of the pages and then a next tag for a next one of the pages and continuing with a different tag for each of the pages in sequential order of the pages leading to a final tag corresponding to a final one of the pages, each tag in the sequence indicating whether a corresponding one of the pages includes or lacks a transition;
comparing the constructed sequence to a set of previously stored sequences in order to identify a matching one of the stored sequences; and,
classifying the multi-page document according to a classification previously associated with the matching one of the stored sequences.

10. The computer program product of claim 9, wherein each tag in the sequence indicates whether a corresponding one of the pages includes a beginning of a new section of the document, an ending of a current section of the document, or includes only content pertaining to the current section of the document.

11. The computer program product of claim 9, wherein the classification indicates a type of the document with known document sections.

12. The computer program product of claim 9, wherein the method further includes generating the previously stored sequences from a training set of corresponding documents of known classification, each known classification being correlated with a specific sequence of tags.
